(19) United States
(12) Patent Application Publication
(10) Pub. No.: US 2021/0164552 A1
(43) Pub. Date: Jun. 3, 2021

(54) Split Power Hydro-Mechanical Transmission with Power Circulation

(71) Applicant: Wieslaw Julian Oledzki, BIALYSTOK (PL)

(72) Inventor: Wieslaw Julian Oledzki, BIALYSTOK (PL)

(21) Appl. No.: 16/699,570

(22) Filed: Nov. 30, 2019

(51) Int. Cl. F16H 47/08

(52) U.S. Cl. CPC F16H 47/085; F16H 2702/00

(57) ABSTRACT

Split power hydro-mechanical transmission includes an input shaft and an output shaft, a torque converter and a planetary gear set, wherein the input shaft is connected to the turbine rotor and the ring gear or the sun gear, the pump rotor is connected to the sun gear or the ring gear, and the output shaft is connected to the planet carrier. This arrangement introduces strong positive feedback between the pump rotor and the turbine rotor, which results in large maximum torque ratio and large rate of growth of torque ratio, as well as large range of (naturally automatic) torque ratio variation.

### TECHNICAL FIELD OF THE INVENTION

The present invention pertains to the field of gears and transmissions, and more specifically to split power continuously variable hydro-mechanical transmissions, and its principal concern is to substantially increase the maximum torque ratio and rate of growth of the output torque, as well as the range of variation of transmission ratio, thus eliminating the need for multi-stage mechanical gears and substantially simplifying transmission structure at the same time.

### STATE OF THE ART AND BACKGROUND OF THE INVENTION

Known “elementary” continuously variable hydrodynamic-mechanical transmissions, composed of hydrodynamic torque converter and single planetary gear set, divides out naturally into two types: Hydrodynamic-mechanical transmissions with input planetary gear set, and hydrodynamic-mechanical transmissions with output planetary gear set. Typical transmission of the first type includes planetary gear set and hydrodynamic torque converter, wherein the gear input (driving) shaft is connected with one member of the planetary gear set (e.g. planet carrier), the hydrodynamic torque converter impeller is connected with another member of the planetary gear set (e.g. sun gear), and the hydrodynamic torque converter turbine rotor is connected with yet another member of the planetary gear set (e.g. ring gear) and output shaft. Typical transmission of the second type includes planetary gear set and hydrodynamic torque converter, wherein the gear output (driven) shaft is connected with one member of the planetary gear set (e.g. planet carrier), the hydrodynamic torque converter turbine rotor is connected with another member of the planetary gear set (e.g. ring gear), and the hydrodynamic torque converter impeller rotor is connected with yet another member of the planetary gear set (e.g. sun gear) and input shaft.

Such composition of the transmission causes the input torque and power delivered to the transmission is divided between two paths, namely the hydrodynamic path, where the driving torque is being continuously changed, and the purely mechanical path, the efficiency of which is larger than that of the hydrodynamic path. Thanks to such composition, overall efficiency of the transmission is larger than that of the torque converter, but the range of transmission ratio change is similar to the range of transmission ratio change of the torque converter. A drawback of this construction is that the maximum torque ratio and rate of rise of the output ratio are diminished in comparison with torque converter itself. Moreover, range of change the transmission ratio is typically 1:1-2:1 to 1:1-2.6:1. Kinetic schemes of such “elementary” hydrodynamic-mechanical transmissions are shown in FIGS. 1A-1L.

In order to extend the range of variation of the output torque (which is necessary for most applications) torque converter is usually combined in single transmission with several (3-5) planetary gear sets through a number of brakes and clutches (in automatic transmissions). Such transmissions are extensively mechanically complicated, and require separate steering systems and hydrostatic gears changing device, which renders them even more complex; moreover, these transmissions are heavy and prone to defects, and costly.

All transmission using torque converter feature good but not excellent rate of output torque rise, and an improvement of this parameter would be precious for emergency, military, and sport vehicles.

Thus there is a need for a simple and inexpensive continuously variable transmission capable of rapidly rising output torque, possessing wide range of variation of output torque, and capable of self-regulating, suitable for wide range of vehicles and working machines subjected during operation to rapidly changing large loads.

### SUMMARY OF THE INVENTION

Thus the principal objective of the present invention is to provide a simple and inexpensive continuously variable transmission with relatively large range of variation of the output torque, which offers large maximum torque ratio rapidly rising when the speed ratio approaches zero, suitable for various vehicles, particularly those destined for start-stop mode of operation, and working machines subjected to heavy loads rapidly varying within broad limits, like passenger cars, city buses, small earth moving machines (e.g. compact track multi-terrain loaders), trucks, off-road vehicles, backhoe loaders, large wheel and track loaders (in which rapidly growing output torque translates to rapidly growing breakout force), dozers, and first of all special purpose vehicles like emergency, military (e.g. tanks), and sport ones (dragsters), where good acceleration is of highest priority.

These and other objectives are achieved according to the present invention by providing a hydrodynamic-mechanical transmission systematically utilizing the phenomenon of power circulation (present in all transmissions using hydrodynamic torque converter). The intense power circulation is attained according to the present invention by introducing a strong positive feedback between the torque converter pump and turbine, which in turn is achieved by way of a specific combination of the torque converter and a planetary gear set, to be described in full detail hereinafter. The range of variation of the transmission ratio of the transmission according to the instant invention (using standard torque converters) is expected to extend from 2:1 to 29:1 and even more, depending on the torque converter used, thus eliminating the need for multi-stage mechanical gears.

### BRIEF DESCRIPTION OF THE DRAWINGS

FIGS. 1A-1L show kinetic schemes of known “elementary” hydrodynamic transmissions being combinations of torque converter and planetary gear set (prior art);

FIG. 2 shows schematically the first preferred embodiment of the invention, wherein the transmission input shaft is connected directly to the torque converter turbine and the ring gear, the pump is connected to the sun gear, and the output shaft is connected to the planet carrier;

FIG. 3 shows exemplary characteristic of conventional torque converter;

FIG. 4 shows exemplary characteristics of the first preferred embodiment of the transmission according to the present invention prepared basing on the torque converter characteristic shown in FIG. 3.

FIG. 5 shows schematically a variant of the first preferred embodiment of the invention, wherein the transmission input shaft is connected directly to the torque converter turbine and the ring gear, the output shaft is connected to the planet carrier, and the torque converter impeller is connected to the sun gear through a direction of rotation reversing gear;

FIG. 6 shows schematically another variant of the first preferred embodiment of the invention, wherein the transmission input shaft is connected to the torque converter turbine and the ring gear through a reduction gear, the output shaft is connected to the planet carrier, and the torque converter impeller is connected to the sun gear;

FIG. 7 shows schematically the second preferred embodiment of the invention, wherein the transmission input shaft is connected directly to the torque converter turbine and the sun gear, the pump is connected to the ring gear, and the output shaft is connected to the planet carrier;

FIG. 8 shows an exemplary (hypothetical) speed multiplication torque converter characteristics;

FIG. 9 shows an exemplary characteristics of the second preferred embodiment of the transmission according to the present invention prepared basing on the torque converter characteristic shown in FIG. 8.

FIG. 10 shows schematically a variant of the second preferred embodiment of the invention, wherein the transmission input shaft is connected to the torque converter turbine and the sun gear through the reduction gear, the impeller is connected to the ring gear, and the output shaft is connected to the planet carrier;

FIG. 11 shows schematically another variant of the second preferred embodiment of the invention, wherein the transmission input shaft is connected to the torque converter turbine and the sun gear, the impeller is connected to the ring gear through a direction of rotation reversing gear, and the output shaft is connected to the planet carrier.

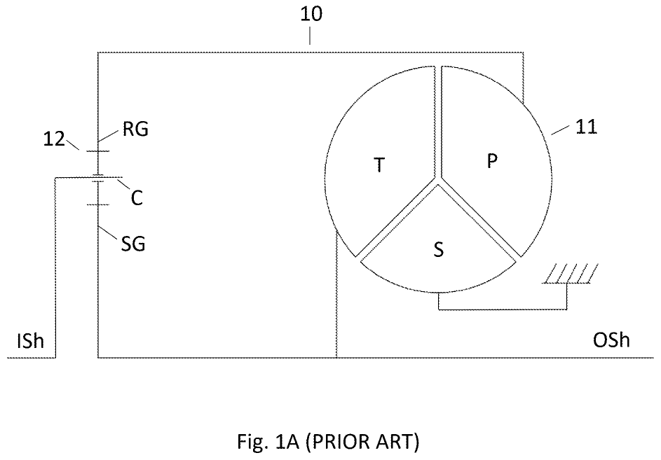

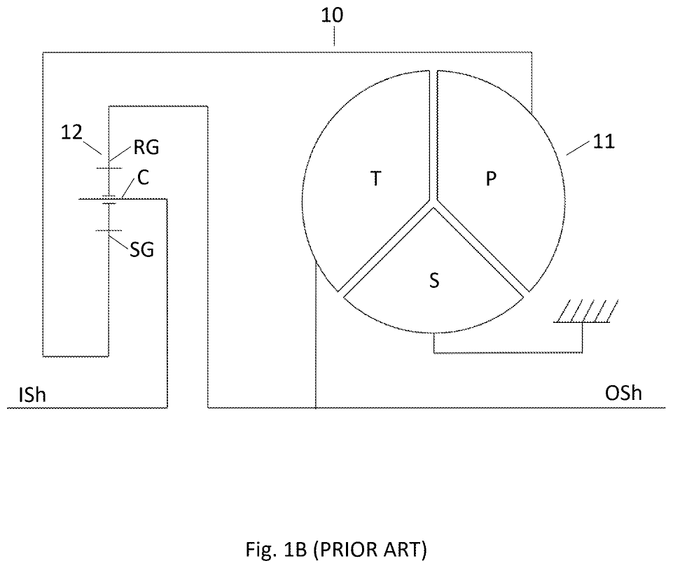

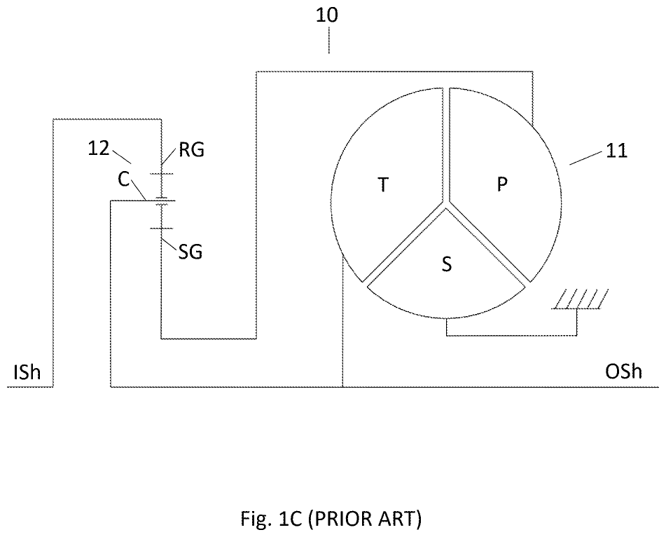

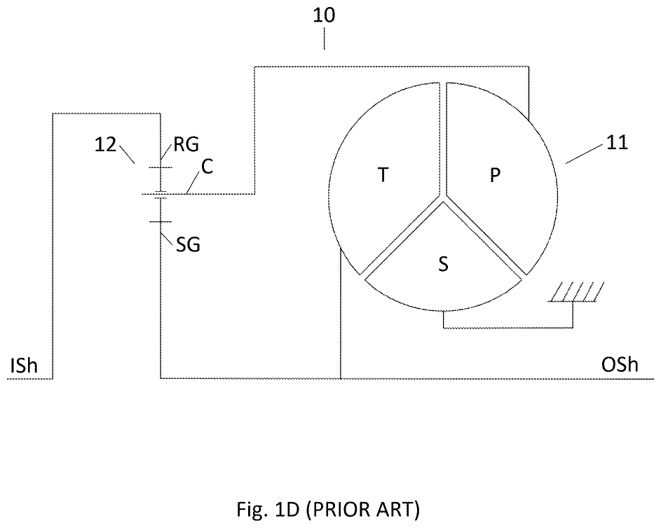

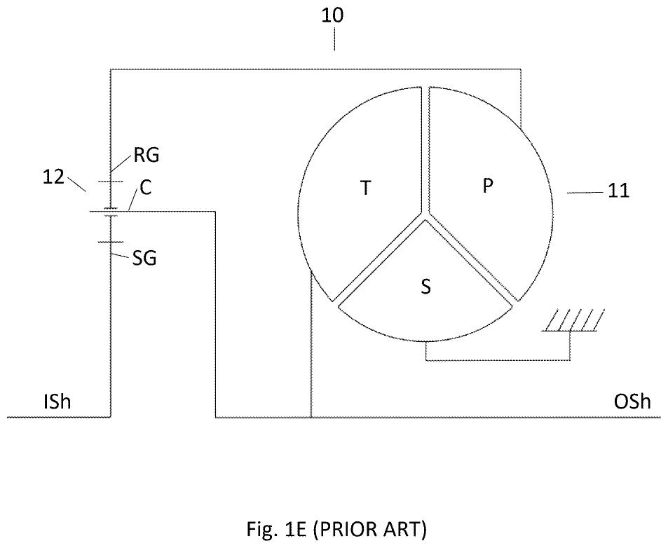

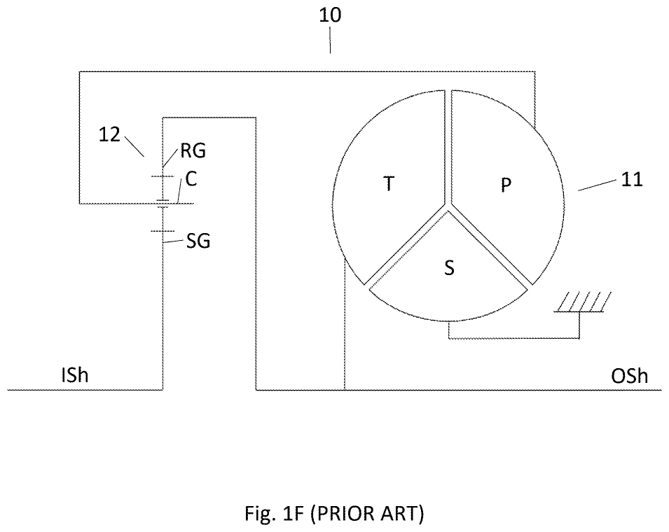

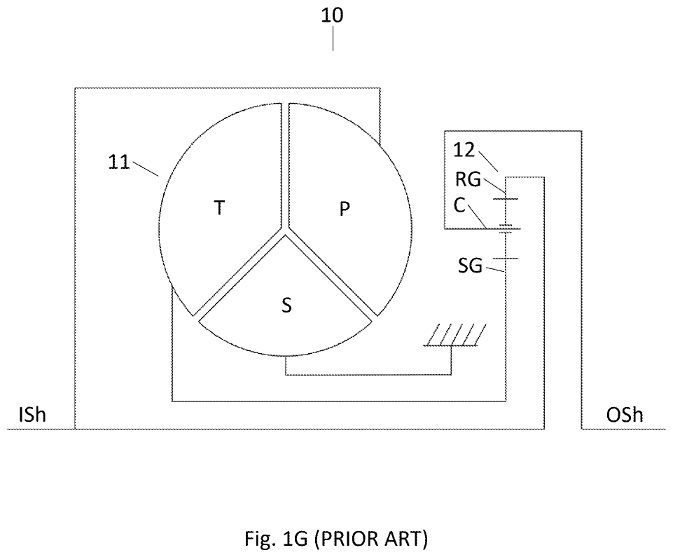

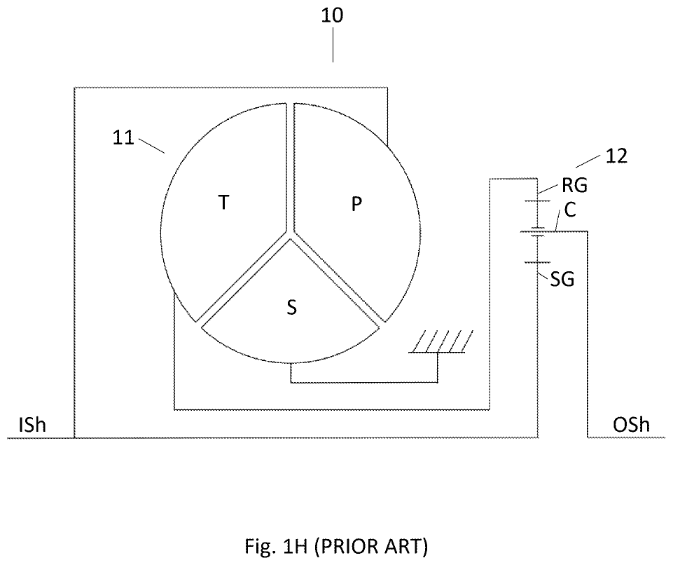

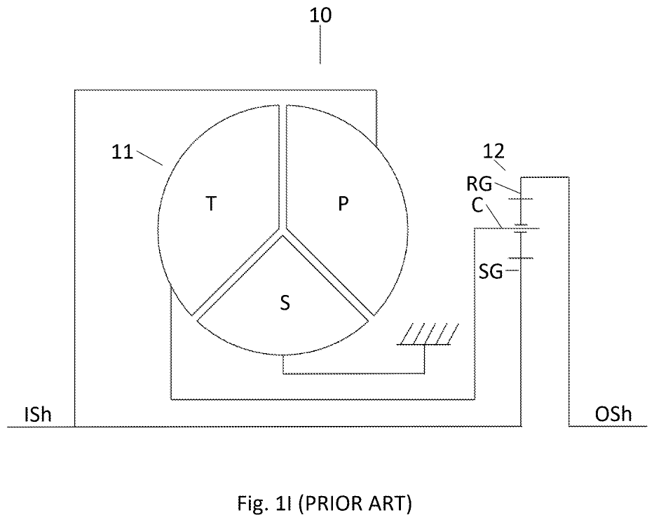

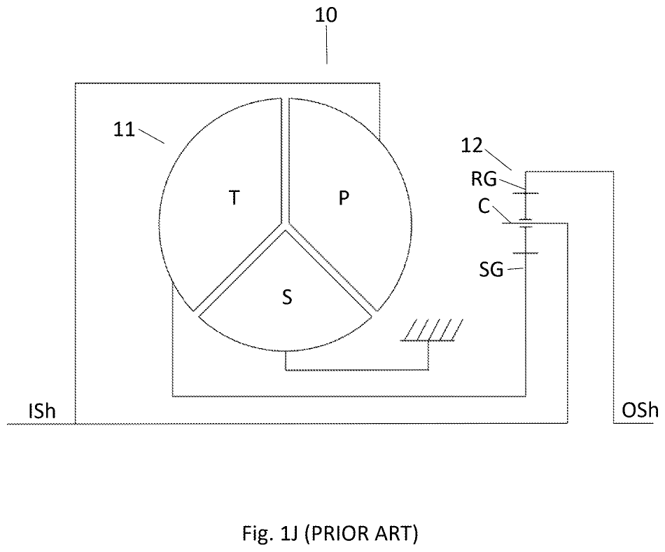

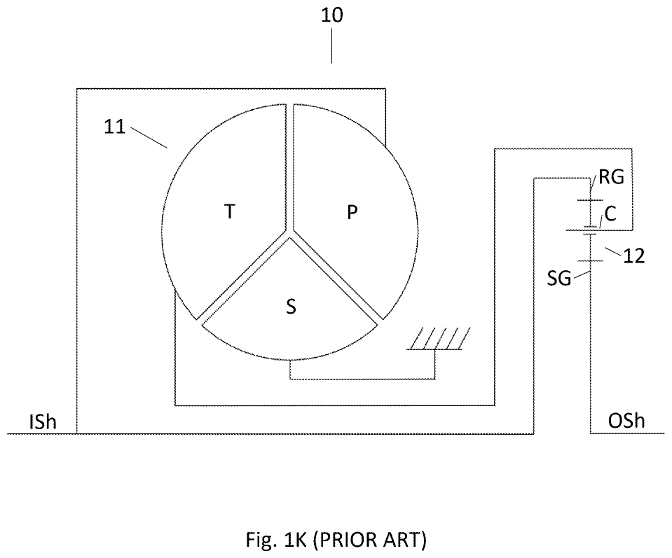

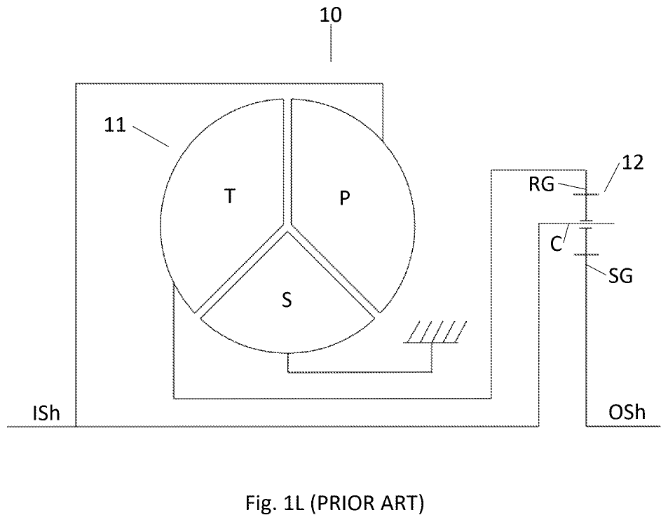

Like symbols denote like transmission elements throughout all the drawings, where:

Numeral 10 refers generally to the transmission of the instant invention;

numeral 11 refers generally to the torque converter;

letter “T” refers generally to the torque converter turbine;

letter “P” refers generally to the torque converter pump or impeller;

letter “S” refers generally to the torque converter stator;

numeral 12 refers generally to the planetary gear set;

letter “C” refers to the planetary gear set's planet carrier;

symbol “SG” refers to the planetary gear set's sun gear;

symbol “RG” refers to the planetary gear set's ring gear;

symbol “ISh” refers to the transmission input shaft;

symbol “OSh” refers to the transmission output shaft;

numeral 13 refers generally to auxiliary direction of rotation reversing gear;

numeral 14 refers generally to the transmission input reduction gear;

symbol “OSh1” refers to the output shaft of the transmission input reduction gear.

### DETAILED DESCRIPTION OF PREFERRED EMBODIMENTS

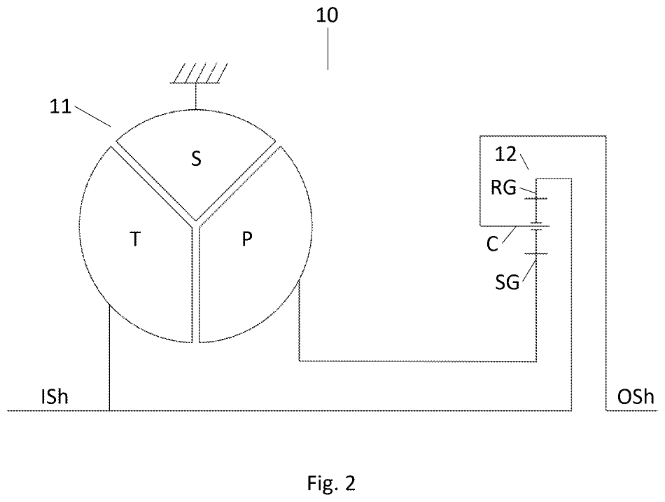

### First Embodiment (FIGS. 2-6)

Transmission according to the present invention 10 includes a typical torque converter 11 (with turbine and impeller rotors rotating in mutually opposite directions), and a typical planetary gear set 12. The transmission input shaft ISh is connected directly to the torque converter 11 turbine rotor T and the planetary gear set's ring gear RG, the transmission output shaft OSh is connected with the planetary gear set's 12 planet carrier C, and the torque converter impeller rotor P is connected directly with the planetary gear set's sun gear. The torque converter of the transmission, according to the presented invention, must be large enough to absorb relatively large circulating power, and to allow to generate large output torque. To be more precise, the torque converter 11 of the transmission according to the instant invention destined for mating with a prime mover having maximum power PP and maximum output torque PT has nominal maximum input power lPP being a multiple of the maximum prime mover's power PP by a factor of l (where typically l ∈ [3,9]), and nominal maximum input torque kPT being a multiple of the maximum prime mover's output torque PP by a factor of k (where typically k ∈ [3,7]). Typically, the base transmission ratio of the planetary gear set 12 (understood as the ratio of the number of teeth on the sun gear over the number of teeth on the ring gear, and denoted by bₜ) is chosen so that the value iₜ(bₜ) of the torque ratio of the torque converter 11 corresponding to the speed ratio iₛ=bₜ equals (depending on the application of the transmission) 40-80% of the maximum torque ratio (on stall) of the torque converter.

It is to be stressed that connecting the torque converter's turbine rotor to the transmission's input shaft does not make it an impeller rotor: The rotor still extracts energy from a fluid flow (directed inwardly, like in radial turbine rotor of any torque converter), and converts it into energy of the rotor, thus adding the power and torque generated by the fluid flow to the power and torque delivered by a prime mover; moreover, this rotor distinguishes from an impeller rotor by hydrofoil profile, and specific placement of the hydrofoil profile relative the hydrofoil profile of the torque converter's stator (rounded (leading) edges of blades of the turbine rotor are placed at external (largest) circumference of the rotor, while sharp (trailing) edges of blades are placed in proximity to the rotor's axis of rotation; in contrast, rounded (leading) edges of blades of radial impeller rotor are always placed in proximity to the rotor's axis of rotation, while sharp (trailing) edges of blades are placed at external (largest) circumference of the impeller rotor).

Now a discussion of the operation (at equilibrium states) of the transmission follows.

Let PS(t) be the output power of the prime mover at the moment t, P, (t)—the circulating power at the moment t, Pₒ(t)—the power on the transmission output shaft, TS(t)—torque delivered by the prime mover at the moment t, Tₜ(t)—torque on the turbine rotor at the moment t, Tᵣ₁(t)=TS(t)+Tₜ(t)—the resultant torque on the transmission input shaft at the moment t, Tₚ(t)—torque on the impeller rotor at the moment t, Tₛ(t)—torque on the planetary gear set sun gear at the moment t (thus Tₛ(t)=Tₚ(t)), Tᵣ₂ (t)—the resultant torque on the transmission output shaft at the moment t (note that the resultant torque on the transmission output shaft is the sum of the torque on the planetary gear set's 12 ring gear, and the torque on the sun gear, i.e. Tᵣ₂(t)=Tᵣ₁(t)+Tₚ(t)), n₁(t)—rotation speed of the output shaft of the prime mover at the moment t (equal to the rotation speed of the transmission input shaft and the turbine rotor), n₂(t)—rotation speed of the transmission output shaft at the moment t (equal to the rotation speed of the planetary gear set's 12 planet carrier C), n₃(g)—rotation speed of the torque converter impeller at the moment t (equal to the rotation speed of the planetary gear set's 12 sun gear SG),

$${i}_{s}^{′} ( t ) = \frac{{n}_{2} ( t )}{{n}_{1} ( t )}$$

is the torque converter speed ratio, iₜ(t) is the torque converter torque ratio, η(iₛ) denotes the torque converter efficiency,

$${i}_{s} ( t ) = \frac{{n}_{1} ( t )}{{n}_{3} ( t )}$$

is the transmission speed ratio, i′ₜ(t) is the transmission torque ratio, η′(i′ₛ) denotes the overall transmission efficiency. During operation of the gear the following equations hold at equilibrium states:
(1) Tᵣ₁(t)=TS(t)+Tₜ(t) (the principal equation characterizing transmission according to the present invention: the resultant torque on the transmission input shaft is the sum of the torque on the prime mover shaft and the torque on the turbine rotor)
   (2) Tₛ(t)=Tₚ(t)
(3) Tᵣ₂(t)=Tᵣ₁(t)+Tₚ(t) (the resultant torque on the planet carrier and the output shaft equals the sum of the torques on the ring and sun gears)

$$\begin{matrix}{T}_{p} ( t ) = {b}_{t} {T}_{r 1} ( t ) & ( 4 ) \\ {T}_{t} ( t ) = {i}_{t} ( {b}_{t} ) {T}_{p} ( t ) & ( 5 ) \\ {n}_{1} ( {t}_{1} ) = {b}_{t} {n}_{3} ( {t}_{1} ) & ( 6 ) \\ η ( {i}_{s} ) = {i}_{s} {i}_{t} & ( 7 ) \\ {i}_{s}^{′} ( t ) = \frac{{i}_{s} ( r ) - {b}_{t}}{{i}_{s} ( t ) + {i}_{s} ( t ) {b}_{t}} ( standard relation for planetary gear set ) & ( 8 ) \\ {η}^{′} ( {i}_{s}^{′} ) = {i}_{t}^{′} {i}_{s}^{′} & ( 9 )\end{matrix}$$

Equations 1-5 immediately yield:

$$\begin{matrix}{T}_{t} ( t ) = \frac{{i}_{t} ( t ) {b}_{t}}{1 - {i}_{t} ( t ) {b}_{t}} T S ( t ) & ( 10 ) \\ {T}_{r 1} ( t ) = \frac{1}{1 - {i}_{t} ( t ) {b}_{t}} T S ( t ) & ( 11 ) \\ {T}_{p} ( t ) = \frac{{b}_{t}}{1 - {i}_{t} ( t ) {b}_{t}} T S ( t ) & ( 12 ) \\ {T}_{r 2} ( t ) = \frac{1 + {b}_{t}}{1 - {i}_{t} ( {i}_{s} ) {b}_{t}} T S ( t ) & ( 13 ) \\ {η}^{′} ( {{ι}^{´}}_{s}^{′} ) = \frac{{i}_{s} - {b}_{t}}{{i}_{s} - η ( {i}_{s} ) {b}_{t}} = \frac{1 - \frac{{b}_{t}}{{i}_{s}}}{{i}_{s} - {i}_{t} ( {i}_{s} ) {b}_{t}} & ( 14 )\end{matrix}$$

Since typically the product iₜ(bₜ)bₜ=η(bₜ) assumes values close to 0.85-0.9 for the value of bₜ close to 0.6, the maximum value Tᵣ₂ₘₐₓ of the output torque at stall is even 10-16 times the maximum output torque of the prime mover. The lower limit of the range of variation of the transmission ratio is defined by the following conditions: Tₚ=bₜTᵣ₁=bₜ(Tₜ+TS), Tₜ=Tₚ, iₛ≅0.9; therefore, for bₜ=0.6, Tᵣ₂≅3.48 TS, and the range of variation of the torque ratio equals [3.48; 12] to [3.48; 16]. Also the rate of growth of the output torque

$$\frac{d}{dt} {T}_{r 2} ( t ) = \frac{1 + {b}_{t}}{1 - {i}_{t} ( {b}_{t} ) {b}_{t}} \frac{d}{dt} T S ( t ) = \frac{1 + {b}_{t}}{1 - η ( {b}_{t} )} \frac{d}{dt} TS ( t )$$

(=10-16 times the rate of growth of the prime mover output torque) is large, and expected to be 3-5 times the rate of growth of the output torque specific for known transmissions.

Since the rotation speed of the turbine rotor equals the rotation speed of the prime mover shaft, this transmission operates at relatively large rotational speeds of the torque converter rotors.

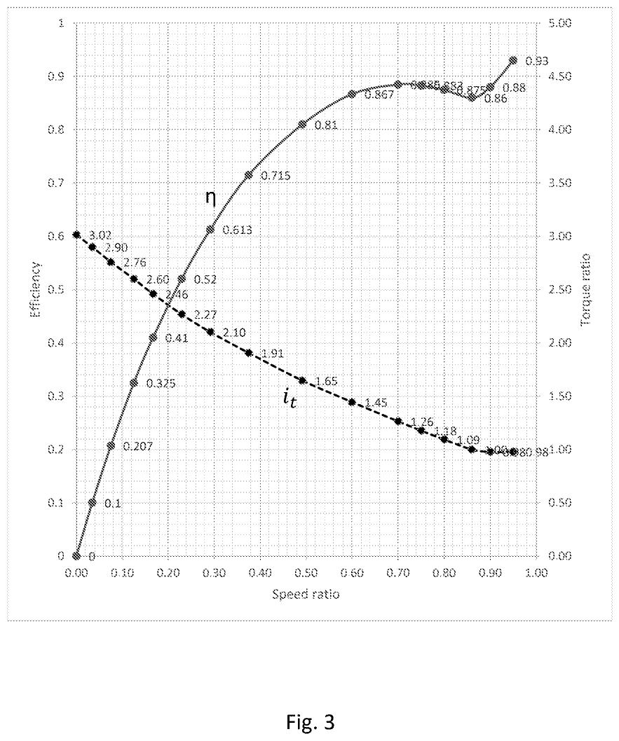

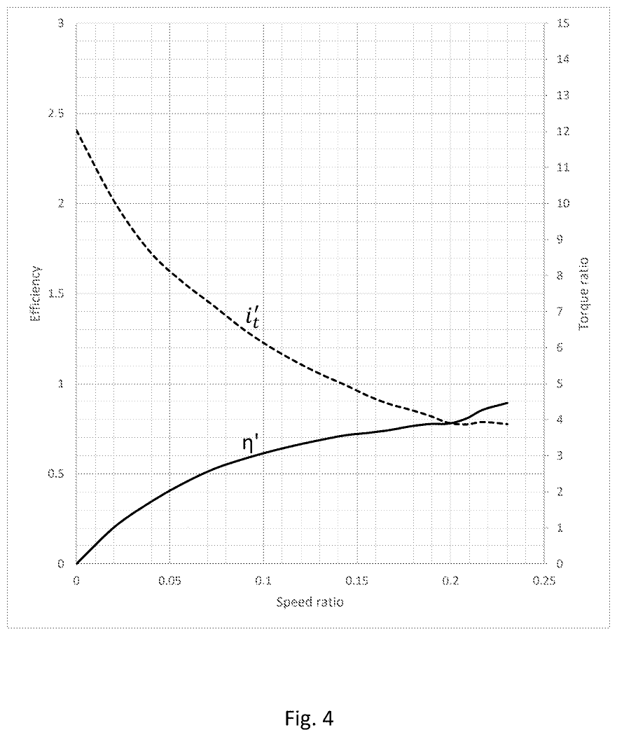

FIG. 4 shows exemplary characteristics of the first embodiment of the transmission according to the present invention equipped with standard torque converter, basing on the standard torque converter characteristic shown in FIG. 3 and equations 13 and 14; unusual parameters of the transmission are easily seen in this figure.

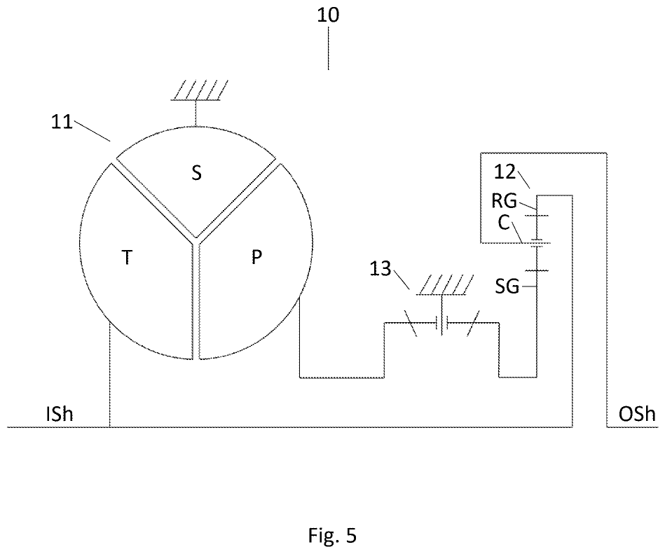

FIG. 5 shows schematically a variant of the first preferred embodiment of the invention, where the transmission input shaft ISh is connected directly to the torque converter turbine T, the output shaft Osh is connected to the planet carrier C, and the torque converter impeller P is connected to the sun gear SG through a direction of rotation reversing gear 13 (which in this case is the ordinary differential with stopped cage), which is the only difference in comparison with the first preferred embodiment described above. The purpose of the direction of rotation reversing gear is to cause the turbine and the impeller rotate in the same direction, as it is the case with the most widespread torque converters. Operation of this transmission is similar to operation of the first variant of the first preferred embodiment of the transmission.

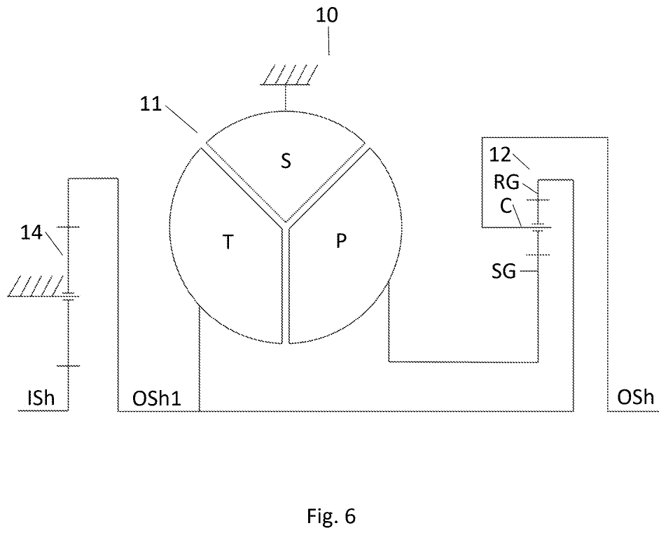

FIG. 6 shows schematically another variant of the first preferred embodiment of the invention, wherein the transmission input shaft ISh is connected to the torque converter turbine T and the ring gear RG through a reduction gear 14, wherein the transmission output shaft OSh is connected to the planet carrier C, the torque converter impeller P is connected to the sun gear SG, and the reduction gear output shaft OSh1 is connected directly to the turbine rotor T. The purpose of the reduction gear 14 is to reduce speed of the torque converter rotors, which may improve the transmission efficiency. Operation of this transmission is similar to operation of the first variant of the first preferred embodiment of the transmission.

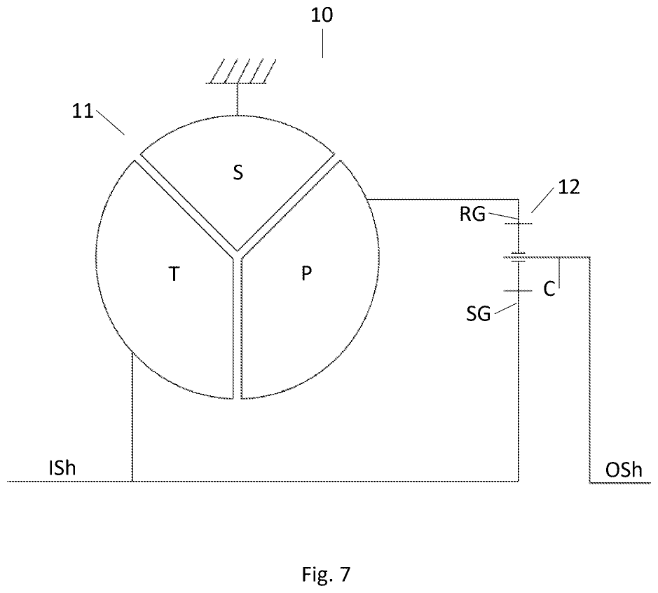

### Second Embodiment (FIGS. 7-11)

The second preferred embodiment of the invention, shown schematically in FIG. 7, and regarded to be of particular interest, differs from the previous embodiment in that the input shaft ISh is connected directly to the turbine T and the sun gear SG (rather than ring gear), the impeller P is connected to the ring gear RG (rather that the sun gear), and the output shaft OSh is connected to the planet carrier C. Such configuration of the transmission enables to obtain substantially larger maximum output torque and rate of growth of the output torque as well as substantially larger range of variation of the output torque; however, an unusual speed multiplication torque converter (in which turbine rotates faster than the impeller) must be used in this transmission.

The following equations hold during operation of the transmission at equilibrium states:

$$\begin{matrix}{T}_{r 1} ( t ) = TS ( t ) + {T}_{t} ( t ) & ( 15 ) \\ {T}_{s} ( t ) = {hT}_{p} ( t ) ; again , for the sake of simplicity , \\ I assume that h = 1 & ( 16 ) \\ {T}_{r 2} ( t ) = {T}_{r 1} ( t ) + {T}_{p} ( t ) & ( 17 ) \\ {T}_{p} ( t ) = \frac{1}{{b}_{t}} {T}_{r 1} ( t ) & ( 18 ) \\ {T}_{t} ( t ) = {i}_{t} ( t ) {T}_{p} ( t ) & ( 19 ) \\ {n}_{1} ( {t}_{1} ) = \frac{1}{{b}_{t}} {n}_{3} ( {t}_{1} ) for {n}_{2} ( {t}_{1} ) = 0 & ( 20 ) \\ η ( {i}_{s} ) = {i}_{s} {i}_{t} & ( 21 ) \\ {i}_{s}^{′} ( t ) = \frac{{b}_{t} {i}_{s} ( t ) - 1}{{i}_{s} ( t ) + {i}_{s} ( t ) {b}_{t}} & ( 22 ) \\ {η}^{′} ( {i}_{s}^{′} ) = {i}_{t}^{′} {i}_{s}^{′} & ( 23 )\end{matrix}$$

Equations 15-23 immediately yield:

$$\begin{matrix}{T}_{t} ( t ) = \frac{{i}_{t} ( t )}{{b}_{t} - {i}_{t} ( t )} TS ( t ) & ( 24 ) \\ {T}_{r 1} ( t ) = \frac{{b}_{t}}{{b}_{t} - {i}_{t} ( t )} TS ( t ) & ( 25 ) \\ {T}_{p} ( t ) = \frac{1}{{b}_{t} - {i}_{t} ( t )} TS ( t ) & ( 26 ) \\ {T}_{r 2} ( t ) = \frac{1 + {b}_{t}}{{b}_{t} - {i}_{t} ( {i}_{s} )} TS ( t ) = \frac{1 + \frac{1}{{b}_{t}}}{1 - \frac{η ( {i}_{s} )}{{i}_{s} {b}_{t}}} TS ( t ) , \\ {i}_{t}^{′} = \frac{1 + \frac{1}{{b}_{t}}}{1 - \frac{η ( {i}_{s} )}{{i}_{s} {b}_{t}}} & ( 27 ) \\ {η}^{′} ( {i}_{s}^{′} ) = \frac{{i}_{s} - \frac{1}{{b}_{t}}}{{i}_{s} - \frac{η ( {i}_{s} )}{{b}_{t}}} ( where {i}_{s} = {i}_{s} ( t ) , etc . ) & ( 28 ) \\ {T}_{r 2 max} = \frac{1 + \frac{1}{{b}_{t}}}{1 - η ( {b}_{t} )} {TS}_{max} & ( 29 ) \\ \frac{d}{dt} {T}_{r 2 stall} = \frac{1 + \frac{1}{{b}_{t}}}{1 - η ( {b}_{t} )} \frac{d}{dt} TS . & ( 30 )\end{matrix}$$

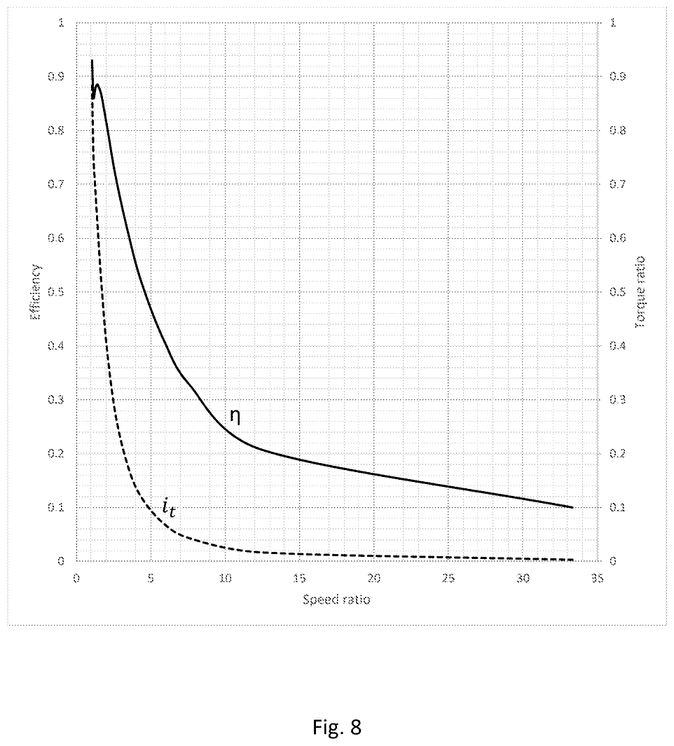

Hypothetical speed multiplication torque converter characteristics shown in FIG. 8 were prepared using characteristics of a conventional torque converter basing on the following Conjecture:

Conjecture/Hypothesis. The efficiency ηₘ(iₛ), resp. the torque ratio iₜₘ(iₛ), of the speed-multiplying torque converter (iₛ≥1), corresponding to the speed ratio iₛ, equals

$$η ( \frac{1}{{i}_{s}} ) ,$$

resp.

$$η ( \frac{1}{{i}_{s}} ) \frac{1}{{i}_{s}}$$

(for iₛ ∈ [a, b] for certain values of a and b), where

$$η ( \frac{1}{{i}_{s}} )$$

is the efficiency of the conventional torque converter for the speed ratio

$$\frac{1}{{i}_{s}}$$

(where the speed ratio is understood as the ratio of the rotational speed of turbine to the rotational speed of pump); thus the efficiency of the hypothetical speed-multiplication torque converter at the speed ratio iₛ≥1, understood as the ratio of the rotational speed of the faster rotor (turbine) to the rotational speed of the slower rotor (pump), is assumed to be equal to the efficiency of the conventional torque converter at the same speed ratio iₛ≥1 understood as the ratio of the rotational speed of the faster rotor (pump) to the rotational speed of the slower rotor (turbine).

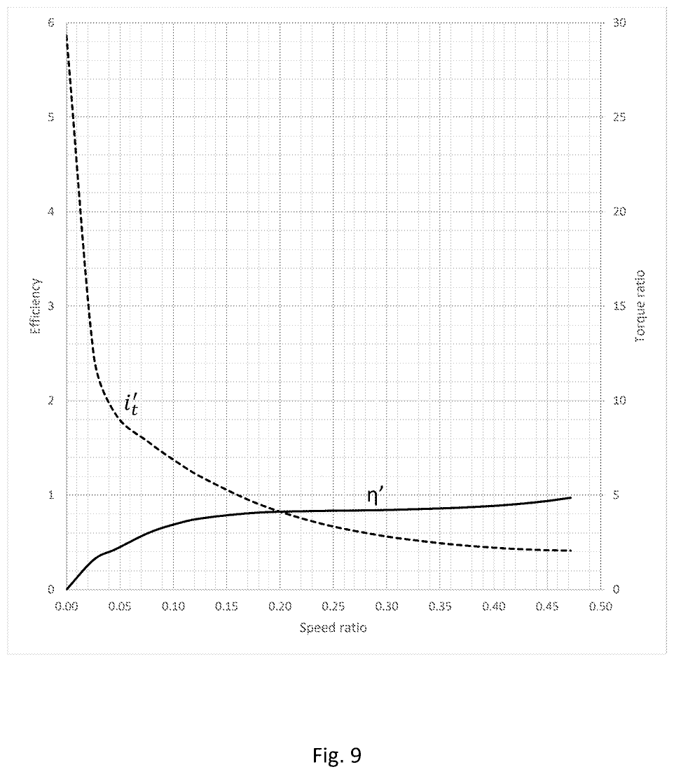

Basing on these speed multiplication torque converter characteristics the transmission characteristics for basis transmission ratio of the planetary gear set bₜ=0.95 were plotted, as shown in FIG. 9.

Thus

$${T}_{r 2 stall} = 29.32 {TS}_{max} , \\ \frac{d}{dt} {T}_{r 2 stall} = 2932 \frac{d}{dt} TS , \\ {T}_{r 2 min} = 2.059 {TS}_{max} , \\ \frac{{T}_{r 2 stall}}{{T}_{r 2 min}} = \frac{{i}_{tmax}^{′}}{{i}_{tmin}^{′}} = 14.24 ,$$

and the overall transmission efficiency varies from 0 at stall to 0.97 for i′ₛ=0.47. The most outstanding, and extremely valuable, feature of this (hypothetical) transmission is its exceptionally large range of variation of torque ratio (defined by

$$\frac{{i}_{tmax}^{′}}{{i}_{tmin}^{′}} = 14.24 ) ,$$

which eliminates, in most applications, the need for multi-stage mechanical gears. Another outstanding feature of this transmission is its good efficiency, which is greater than 0.8 for speed ratio i′ₛ ∈ (0.17, 0.47), i.e. for speed ratios covering 64% of the whole range of the speed ratio variation. Since the efficiency η of the torque converter varies within the limits 0.87-0.1 as the transmission speed ratio i′ₛ varies within the limits 0.17-0.47 (which was computed using equations Eq. (28) and Eq. (34)), this points out to large share of the power being transferred by the mechanical branch of the transmission for i′ₛ ∈ (0.17, 0.47). Very rapid growth of torque ratio for speed ratio i′ₛ→0, and exceptionally large torque ratio at stall can also be seen in FIG. 9. These features of the transmission being discussed render it very attractive for loaders and dozers and other heavy machinery.

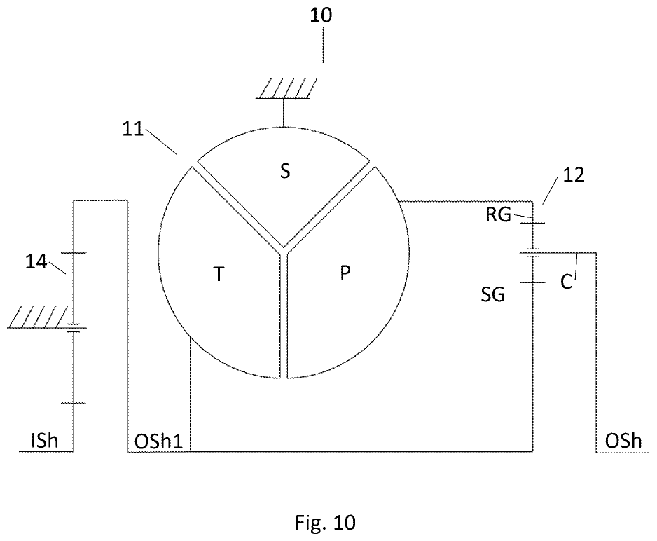

FIG. 10 shows schematically another variant of the second preferred embodiment of the invention, wherein the transmission input shaft ISh is connected to the torque converter turbine T and the sun gear SG through a reduction gear 14, wherein the output shaft OSh is connected to the planet carrier C, the torque converter impeller P is connected to the ring gear RG, and the reduction gear output shaft OSh1 is connected directly to the turbine rotor T. The purpose of the reduction gear 14 is to reduce speed of the torque converter rotors, which may improve the transmission efficiency. Operation of this transmission is similar to operation of the first variant of the first preferred embodiment of the transmission.

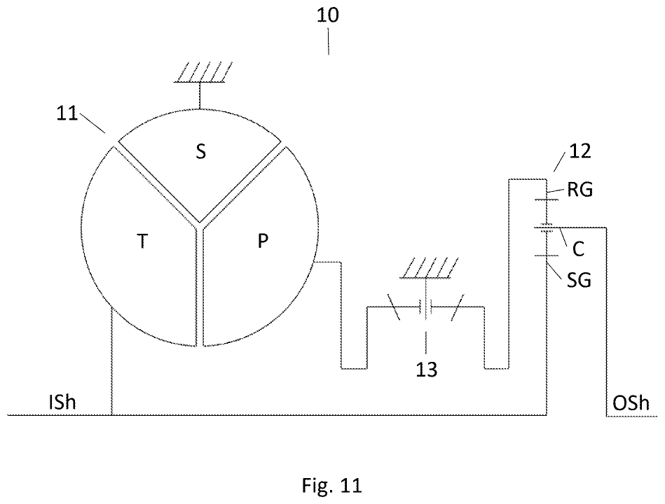

FIG. 11 shows schematically a variant of the second preferred embodiment of the invention, where the transmission input shaft ISh is connected directly to the torque converter turbine T and the sun gear SG, the output shaft Osh is connected to the planet carrier C, and the torque converter impeller P is connected to the ring gear RG through a direction of rotation reversing gear 13 (which in this case is the ordinary differential with stopped cage), which is the only difference in comparison with the second preferred embodiment described above. The purpose of the direction of rotation reversing gear is to cause the turbine and the impeller rotate in the same direction, as it is the case with the most widespread torque converters. Operation of this transmission is similar to operation of the first variant of the second preferred embodiment of the transmission.

I claim:

1. A hydro-mechanical transmission with power circulation includes at least: a first body;
an input shaft supported rotatably in said first body; an output shaft supported rotatably in said first body; a hydrodynamic torque converter having at least: a second body filled with a hydraulic fluid, a turbine rotor, a pump rotor, and a stator secured against rotation relative the body; and a planetary gear set having a sun gear, a ring gear, a first number of planet gears, and a planet gears carrier; wherein the input shaft is connected directly to the turbine rotor; wherein at any moment t the total torque Tᵣ₁(t) on the transmission input shaft, the torque TS(t) supplied to the input shaft by the engine, and the torque Tₜ(t) on the turbine rotor generated by the flow of the hydraulic fluid satisfy the following equation: Tᵣ₁(t)=TS(t)+Tₜ(t).

2. The hydro-mechanical transmission with power circulation according to claim 1, wherein the output shaft is connected to the planet carrier, the input shaft is connected directly to the turbine rotor and the ring gear, and the pump rotor is connected directly to the sun gear; wherein at any moment t the total torque Tᵣ₁(t) on the transmission input shaft, and the torque TS(t) supplied to the input shaft by the engine satisfy the following equation:
$${T}_{r 1} ( t ) = \frac{1}{1 - {i}_{t} ( t ) {b}_{t}} TS ( t ) ,$$
wherein bₜ is the planetary gear set's base transmission ratio, wherein the planetary gear set's base transmission ratio bₜ is the ratio of the number of teeth on the sun gear over the number of teeth on the ring gear, wherein iₜ(t) is the torque converter's torque ratio at the moment t, wherein the torque converter's torque ratio at the moment t iₜ(t) is the ratio of the torque on the turbine rotor at the moment at the moment t over the torque on the pump rotor at the moment at the moment t; wherein at any moment t the total torque Tᵣ₂(t) on the transmission output shaft and the torque TS(t) supplied to the input shaft by the engine satisfy the following equation
$${T}_{r 2} ( t ) = \frac{1 + {b}_{t}}{1 - {i}_{t} ( t ) {b}_{t}} TS ( t ) .$$

3. The hydro-mechanical transmission with power circulation according to claim 1, wherein the output shaft is connected to the planet carrier, the input shaft is connected directly to the turbine rotor and the sun gear, and the pump rotor is connected directly to the ring gear; wherein at any moment t the total torque Tᵣ₁(t) on the transmission input shaft, and the torque TS(t) supplied to the input shaft by the engine satisfy the following equation:
$${T}_{r 1} ( t ) = \frac{{b}_{t}}{{b}_{t} - {i}_{t} ( t )} T S ( t ) ,$$
wherein bₜ is the planetary gear set's base transmission ratio, wherein the planetary gear set's base transmission ratio bₜ is the ratio of the number of teeth on the sun gear over the number of teeth on the ring gear, wherein iₜ(t) is the torque converter's torque ratio at the moment t, wherein the torque converter's torque ratio at the moment t iₜ(t) is the ratio of the torque on the turbine rotor at the moment at the moment t over the torque on the pump rotor at the moment at the moment t; wherein at any moment t the total torque Tᵣ₂(t) on the transmission output shaft and the torque TS(t) supplied to the input shaft by the engine satisfy the following equation:
$${T}_{r 2} ( t ) = \frac{1 + {b}_{t}}{{b}_{t} - {i}_{t} ( t )} TS ( t ) .$$

4. The hydro-mechanical transmission with power circulation according to claim 3, wherein the torque converter is a speed multiplication torque converter, in which the turbine rotor rotates faster than the pump rotor.

5. The hydro-mechanical transmission with power circulation according to claim 1, wherein the pump rotor is connected to the sun gear through a direction of rotation reversing gear.

6. The hydro-mechanical transmission with power circulation according to claim 1, wherein the pump rotor is connected to the ring gear through a direction of rotation reversing gear.

7. A hydro-mechanical transmission with power circulation includes at least: a first body; an input shaft supported rotatably in said first body; a first output shaft supported rotatably in said first body; a hydrodynamic torque converter having at least: a second body filled with a hydraulic fluid, a turbine rotor, a pump rotor, and a stator secured against rotation relative the second body; a planetary gear set having a sun gear, a ring gear, a first number of planet gears, and a planet gears carrier; and a speed reduction gear, having at least a first rotary member, a second rotary member, and a second output shaft; wherein the input shaft is connected to the first rotary member of the speed reduction gear, and the second output shaft of the speed reduction gear is connected directly to the second rotary member of the speed reduction gear and to the turbine rotor; wherein at any moment t the total torque Tᵣ₁(t) on the second output shaft, the torque TS(t) supplied to the input shaft by the engine, and the torque Tₜ(t) on the turbine rotor generated by the flow of the hydraulic fluid satisfy the following equation:
$${T}_{r 1} ( t ) = \frac{1}{ρ} η T S ( t ) + {T}_{t} ( t ) ,$$
wherein ρ is the kinematic transmission ratio of the speed reduction gear, and η is the efficiency of the speed reduction gear.

8. The hydro-mechanical transmission with power circulation according to claim 7, wherein the first output shaft is connected to the planet carrier, the second output shaft of the speed reduction gear is connected to the ring gear, and the pump rotor is connected directly to the sun gear.

9. The hydro-mechanical transmission with power circulation according to claim 7, wherein the first output shaft is connected to the planet carrier, the second output shaft of the speed reduction gear is connected to the sun gear, and the pump rotor is connected directly to the ring gear.

10. The hydro-mechanical transmission with power circulation according to claim 9, wherein the torque converter is a speed multiplication torque converter, in which the turbine rotor rotates faster than the pump rotor.

11. The hydro-mechanical transmission with power circulation according to claim 7, wherein the pump rotor is connected to the sun gear through a direction of rotation reversing gear.

12. The hydro-mechanical transmission with power circulation according to claim 7, wherein the pump rotor is connected to the ring gear through a direction of rotation reversing gear.
